(19) United States
(12) Patent Application Publication
(10) Pub. No.: US 2008/0204359 A1
(43) Pub. Date: Aug. 28, 2008

(54) ELECTRONIC DISPLAY DEVICE FOR DISPLAYING DIGITAL IMAGES

(75) Inventors: Chi-Ying TSUI, Hong Kong (CN); Ping KOW, Hong Kong (CN); Kai Kin CHAN, Hong Kong (CN); Chor Tin MA, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: PERCEPTION DIGITAL LIMITED, Hong Kong SAR (CN)

(21) Appl. No.: 11/736,122

(22) Filed: Apr. 17, 2007

(30) Foreign Application Priority Data
Feb. 28, 2007 (HK) 07102294.2

(51) Int. Cl. G09G 5/00

(52) U.S. Cl. 345/5

(57) ABSTRACT

A display device has a screen for displaying digital images located on a housing that encloses a storage medium for storing the digital images, and a processor for performing functions such reading images from the storage medium and displaying the images on the display screen. A frame detachably securable to the housing surrounds the display screen, and electronically communicates with the processor when secured to the housing for configuring how the processor performs the functions of the display device.

### BACKGROUND OF THE INVENTION

1. Field of the Invention

The present invention relates to electronic display devices and in particular to electronic display devices for displaying one or more digital images such as a digital photo frame for displaying digital photographs stored on a removable memory card.

2. Background Information

Digital photo frames are well known. They comprise a housing with a stand and a front face having a display screen such as LCD panel. The device has a card slot for receiving a non-volatile memory card from a digital camera or the like and a processor for reading images from the card and displaying the images on the screen. Digital photo frames typically have several display modes for displaying a single still image or a series of images in a slide show with a variety of different transactions between the images. The current inventors believe that digital photo frames can be improved by providing means for greater customisation of the photo frame and of the display or slide show experience.

Accordingly, it is an objective of the present invention to provide an electronic display device, such as a digital photo frame, for displaying one or more digital images which is customisable either aesthetically and/or electronically for displaying images in a variety of different themes or modes, or which at least provides the public with a useful alternative to currently known digital photo frames.

### SUMMARY OF THE INVENTION

Accordingly there is disclosed herein an electronic display device for displaying one or more digital images, comprising a housing having a face with a display screen, a storage medium for storing a plurality of digital images, and a processor for performing functions of the display device including reading images from the storage medium and displaying the images on the display screen, and a frame detachably securable to the housing for surrounding the display screen, the frame electronically communicating with the processor when the frame is secured to the housing for configuring how the processor performs the functions of the display device.

Preferably, the housing has a first electronic connection device, and the frame has a second electronic connection device configured to communicate with the first electronic connection device when the frame is secured to the housing for controlling how the processor performs the functions of the display device.

Preferably, the first and second electronic connection devices are contactless communication devices.

Preferably, the first electronic connection device comprises a conductive terminal and the second electronic connection device comprises a conductive pin to engage with the conductive terminal of the housing when the frame is secured to the housing.

Preferably, the first and second electronic connection devices comprise two or more of said conductive terminals and pins respectively, the frame further comprising a low resistance path between the two or more conductive pins such that the low resistance path is connected between the two or more terminals of the housing, between which the resistance is normally much greater, when the frame is secured to the housing.

Preferably, the frame further comprises a non-volatile electronic storage medium connected to the second electronic connection device and configured to be accessible by the processor when the frame is secured to the housing.

Preferably, the non-volatile electronic storage medium comprises computer readable operating instructions for the processor.

Preferably, the non-volatile electronic storage medium has stored thereon one or more of audio, video or image media files for playing on the electronic display or operating instructions for the processor.

Preferably, the frame further includes a user operable input device, said input device connected to the second electronic connection device and configured to provide input to the processor when the frame is secured to the housing

Preferably, the frame further comprises a non-volatile electronic storage medium and a frame processor for controlling functions of the frame.

Preferably, frame processor is connected to the second electronic connection device and configured to communicate with the processor when the frame is secured to the housing.

Preferably, the frame has a mask defining two or more display regions of the display screen and is configured to control the processor to simultaneously display different ones of the images in the two or more display regions of the display screen.

Preferably, the storage medium is a removable memory card received within a card slot in the housing.

Further aspects of the invention will become apparent from the following description and drawings which are given by way of example only.

### BRIEF DESCRIPTION OF THE DRAWINGS

Embodiments of the invention will now be described with reference to the accompanying drawings in which:

FIG. 1 is a schematic perspective view of a digital photo frame according to the invention,

FIG. 2 is a schematic front view of the digital photo frame main unit 22 of FIG. 1,

FIG. 3 is a schematic view of the detachable front panel 21 of FIG. 1,

FIGS. 4 illustrates different detachable front panels,

FIG. 5 is a schematic illustration of the photo frame electronics, and

FIG. 6 is a schematic flow diagram of the photo frame's operation.

### DETAILED DESCRIPTION OF THE PREFERRED EMBODIMENT

The invention will now be described as practiced in a digital photo frame which is supported on a service in the same manner as a traditional photo frame but which has a small LCD screen in the photo area of the frame, a card slot for receiving a non-volatile memory card such as those used in digital cameras and a processor for reading image files stored on the memory card and displaying the image files on the LCD screen. However, this is not intended to limit the scope of use or functionality of the invention. It will be appreciated by the skilled addressee that the invention can be applied to any electronic display device for displaying one or more digital images whether those images are still images such as photos or video images. The invention is not limited to a small photo frame type display but could be a larger wall mounted display or a LCD, Plasma or similar flat panel TV or other display device.

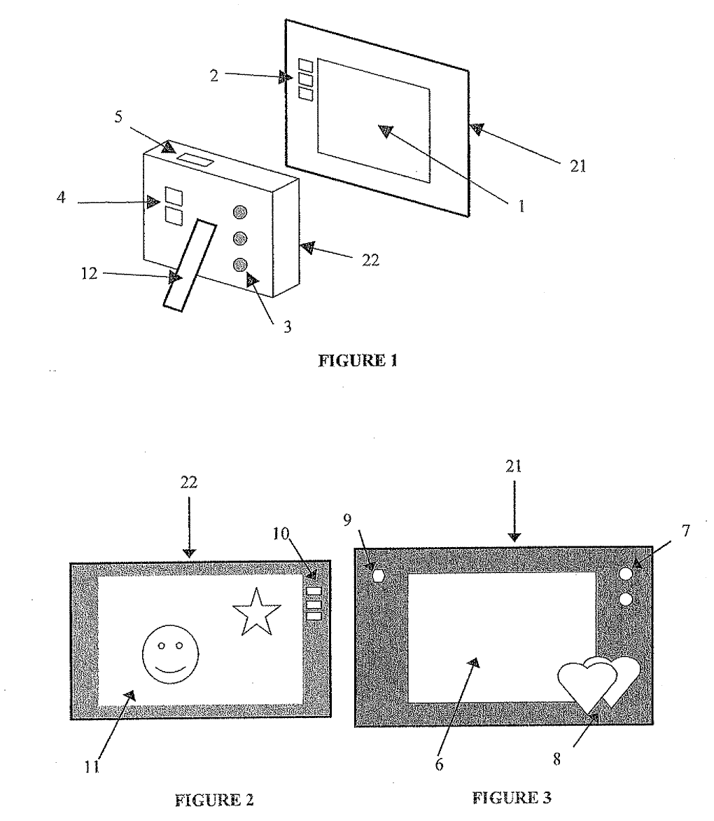

Referring to FIGS. 1-3, a digital photo frame device according to the invention comprises a substantially rectangular shaped housing 22 having a front display face and a back panel Mounted in the front face is a LCD screen 11 for displaying digital images and video images. Attached to the back panel and adapted for supporting the housing inclined on its edge is a support led 12. The housing has on its top edge a card slot 5 for receiving an external memory card such as a SD card, memory stick, compact flash card or other non-volatile removable memory device known in the art. On the back panel of the housing are USB connectors ports 4 for connecting to a PC, Wi-Fi dongle, Bluetooth dongle or thumb drive etc and three user input buttons 3 provided for controlling certain functions of a device. A processor 20 within the housing is connected to the card slot 5, USB connectors 4, input buttons 3 and LCD screen 11 for performing the operations of the device. The processor 20 in its primary function reads image files stored on a removable memory card inserted into the card slot 5 and displays the images on the LCD screen 11 either as a static image or in a slide show. An electronic connection device 10 is provided on the front face of the housing 22 and connected with the processor 20. A s speaker for audio output is not shown, but can de provided as will become apparent later in the description.

A detachable decorative frame 21 having a transparent widow 6 is secured to the front face and surrounds the LCD screen 11 for providing a decorative finish to the digital photo frame. The method of detachably securing the frame 21 to the housing 22 is not important to the invention and several suitable methods will be apparent to the skilled addressee. A plurality of detachable frames 21 can be provided with the digital photo frame housing or sold separately so that a user or users of the device can customise the external look of the digital photo frame to suit a room or space decor, a particular festive season in which the frame is being used or to match the type of photos being displayed on the frame. In addition, the detachable frame 21 is provided with an electronic connection device 2 that communicates with the first electronic connection device 4 of the housing when the frame 21 is secured to the housing 22 so that the detachable frame 21 may communicate with the processor 20 and thereby customise the electronic display experience and/or functions of the photo frame.

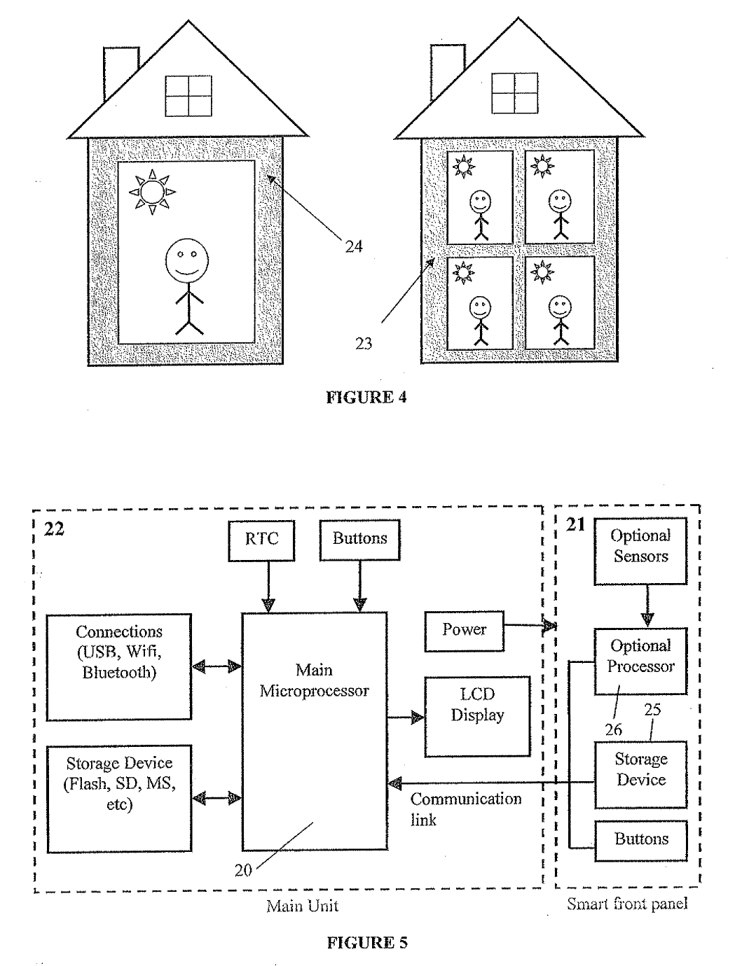

In the preferred embodiment the communication devices 2, 4 are contact terminals and pins respectively that are configured to communicate when the frame 21 is secured to the housing B. On the front face of the housing 22 adjacent the LCD screen 11 are a number of electrically conductive contact terminals 4. Electronically conductive contact pins 2 are provided on the inside surface of the detachable frame 21 such that one or more of the pins 2contact the terminals 4of the housing when the detachable frame 21 is secured to the housing B. The detachable frame 21 has a low resistance path between two or more of the conductive pins 2 and when the pins 2 are in contact with the housing terminals 4 the low resistance conductive path is provided between the housing 22 terminals 4 providing an input signal to the processor 20 to configure the fraction or mode of operation of the device and/or how images are displayed on the LCD screen 11. For example, one detachable frame 21 may be a photo frame which when secured to the housing 22 instructs the processor 20 to read image files from a removable memory card in the card slot 5 and display the images on the LCD screen 11 in accordance with user selected inputs set by control buttons 3 on the back panel of the housing B. A second detachable frame 21 may represent a watch or clock bezel having hour and minute markings around the outside of the detachable frame A. When this clock frame is secured to the housing 22 a different pin configuration on the detachable clock frame 21 instructs the processor 20 to display clock hands on the LCD screen 11 to indicate the time against the hour and minute markings around the frame A. A third detachable frame 23, for example as shown in FIG. 4, includes a mask that defines several smaller image areas within the LCD screen 11 and contact pins 2 on the photo frame 23 inform the processor 20 to simultaneously display two or more images stored on the removable memory card within areas of the LCD screen defined by the mask of the frame. A forth detachable frame 24, for example as shown in FIG. 4, includes a graphic such as a shape of a house or some other object with a window defining the viewing area of the LCD screen 11. The connection device on the detachable frame 24 tells the processor 20 how the images should be displayed within the frame window to complete the customisation of the photo frame.

In an alternative embodiment of the digital photo frame, the electronic connection devices 2, 4 in the detachable frame and housing are contactless communication devices that provide electronic communication between the detachable frame and housing when respective contactless connection devices in the detachable frame and housing are brought into close proximity by securing the detachable frame to the housing. Such contactless connection devices are well known in the art and could be, for example, a simple proximity switch in the housing reactive to the detachable frame or to an element within the detachable frame, a magnetic coupling such as a reed switch mounted in the housing and a small magnet mounted with the detachable frame or some form of smart contactless communication means such as those commonly in access control systems.

In a another embodiment of the digital photo frame, the detachable frame includes an embedded storage medium 25 such as non-volatile electronic memory in which there can be stored computer readable files such as icons, graphic or audio files and operating instructions for the processor 20. The storage medium 25 is connected with the electronic connection device of the detachable frame so that the storage device is accessible by the microprocessor 20 when the detachable frame 21 is connected to the housing. When a detachable frame having such an embedded memory medium 25 is connected to the housing and the memory is detected by the processor 20 the processor 20 accesses the memory 25 to check for recognisable files thereon. If the processor 20 finds processor operating instructions then the instructions are transferred to processor memory and run by the processor 20. If the process also or alternatively finds media files such as still images, video or audio files then the media files are played on the LCD screen in accordance with associated operating instructions or standard photo frame settings. In one aspect of such an embodiment the detachable frame memory 25 contains an audio file that is played on an internal speaker while displaying images from the removable memory card in the card slot. Such an arrangement might be useful for specific detachable frames dedicated to certain event or seasons such as a weddings, birthdays or Christmas. In a second aspect of this embodiment the detachable frame memory 25 contains icons and graphic files which are played in association or over images from the removable memory card being displayed on the LCD screen. For example, the detachable frame graphics may be small icons or image that move around the LCI) screen over the photo being displayed.

In yet a further embodiment of the invention the detachable frame may also include its own frame processor 26 for operating functions of the detachable frame 21. In this embodiment the detachable frame may include LEDs and/or other illumination means for example small graphic inserts 8 around the detachable frame that the frame processor 26 controls in association with the display of images on the LCD screen by the housing processor 20. The frame processor 26 receives a power supply via the electronic connection device and also communicates with the main processor 20 in the housing for controlling the output functions such as how the images are displayed on the LCD screen. The detachable frame may also include optional user input buttons 7 and/or sensors 9 such as proximity sensors, cameras and the like which can serve as input functions for the photo frame. For example the frame may include user input buttons 7 on the detachable frame 21 that are interpreted by the frame processor 26 and operating control commands sent to the housing processor 20. The detachable frame may include a proximity sensor 9 and/or a camera for detecting the presence or an image of a person near the frame and relaying the image or presence information to the housing processor 20 for controlling operation or displaying photos on the LCD screen.

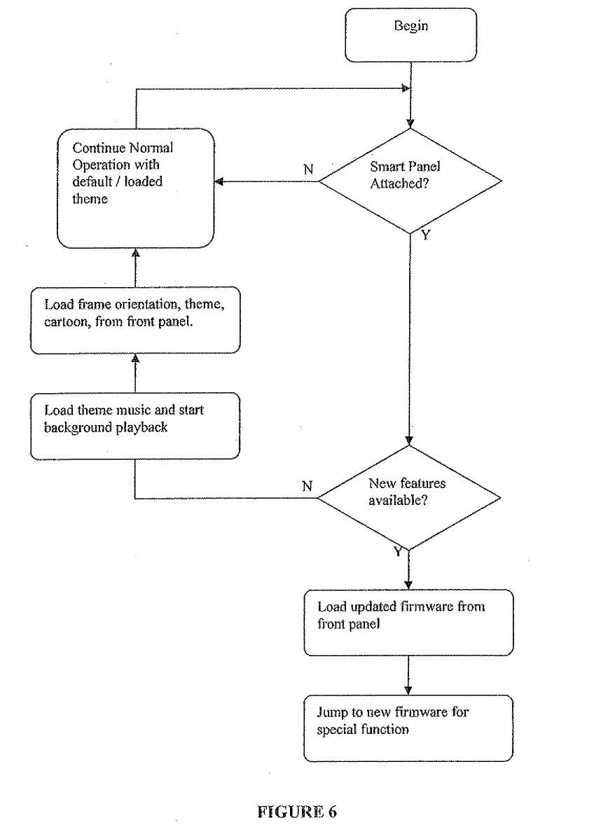

FIG. 6 shows a flow diagram of the operation of the housing processor 20 in later embodiments of the digital photo frame. At the first decision block the main processor 20 decides whether a smart detachable frame having embedded memory or a frame processor 26 is attached to the housing. If no embedded memory or a frame processor 26 is detected then the processor 20 moves to normal operation of the photo frame. If an embedded memory or a frame processor 26 is detected then the processor 20 looks to see whether the detachable frame has any operating instructions or features on its storage medium that must be auctioned by the processor 20. If the storage medium of the detachable frame includes firmware or operating instructions for a new function or unique mode of operation of the device said firmware is loaded to the processor 20 and the processor 20 performs the new functions. If no such control-software is detected but standard themes and/or media contents is detected on a memory device of the detachable frame then such media is loaded and displayed in accordance with the normal operation of the frame.

One particular advantage of the device with detachable frame storage medium 25 is that a user can define photograph collections to store on a detachable frame for display when that frames is attached to the photo frame housing. For example, a user may have a series of favorite Christmas images which can be tagged and loaded to a detachable frame having a Christmas theme. When the detachable frame is secured to the housing the processor 20 loads the Christmas images from the detachable frame memory and displays the Christmas images on the LCD screen. In another example a detachable frame may have a wedding theme and can load wedding photos to the detachable frame memory which are displayed when the wedding frame of attached to the housing.

1. An electronic display device for displaying one or more digital images, comprising:
a housing having a face with a display screen, a storage medium for storing a plurality of digital images, and a processor for performing functions of the display device including reading images from the storage medium and displaying the images on the display screen, and
a frame detachably securable to the housing for surrounding the display screen, the frame electronically communicating with the processor when the frame is secured to the housing for configuring how the processor performs the functions of the display device.

2. An electronic display device for displaying one or more digital images, comprising:
a housing having a face with a display screen, a storage medium for storing a plurality of digital images, a processor for performing functions of the display devices including reading images from the storage medium and displaying the images on the display screen, and a first electronic connection device, and
a frame detachably securable to the housing for surrounding the display screen, the frame having a second electronic connection device configured to communicate with the first electronic connection device when the frame is secured to the housing for controlling how the processor performs the functions of the display device.

3. The electronic display of claim 2 wherein the first and second electronic connection devices are contactless communication devices.

4. The electronic display of claim 2 wherein the first electronic connection device comprises a conductive terminal and the second electronic connection device comprises a conductive pin to engage with the conductive terminal of the housing when the frame is secured to the housing.

5. The electronic display of claim 4 wherein the first and second electronic connection devices comprise two or more of the conductive terminals and pins_ respectively, the frame further comprising a low resistance path between the two or more conductive pins such that the low resistance path is connected between the two or more terminals of the housing, between which the resistance is normally much greater, when the frame is secured to the housing.

6. The electronic display of claim 2 wherein the frame further comprises a non-volatile electronic storage medium connected to the second electronic connection device and accessible by the processor when the frame is secured to the housing.

7. The electronic display of claim 6 wherein the non-volatile electronic storage medium comprises computer readable operating instructions for the processor.

8. The electronic display of claim 6 wherein the non-volatile electronic storage medium has stored one or more of audio, video, and image media files for playing on the electronic displays or operating instructions for the processor.

9. The electronic display of claim 2 wherein the frame further includes a user operable input device, the input device being connected to the second electronic connection device and providing an input to the processor when the frame is secured to the housing

10. The electronic display of claim 2 wherein the frame further comprises a non-volatile electronic storage medium and a frame processor for controlling functions of the frame.

11. The electronic display of claim 10 wherein frame processor is connected to the second electronic connection device and communicates with the processor when the frame is secured to the housing.

12. The electronic display of claim 2 wherein the frame has a mask defining two or more display regions of the display screen and controls the processor to simultaneously display different ones of the images in the two or more display regions of the display screen.

13. The electronic display of claim 2 wherein the storage medium is a removable memory card received within a card slot in the housing.
